(19) United States
(12) Patent Application Publication
(10) Pub. No.: US 2008/0016928 A1
(43) Pub. Date: Jan. 24, 2008

(54) INTERCHANGEABLE LOCK CORE CYLINDER

(76) Inventors: Ju-Lin YANG, Chiayi County (TW); Lan-Kun DON, Chiayi City (TW); Ching-Chuan KUO, Chiayi County (TW); Po-Yang CHEN, Chiayi City (TW); Tsung-Chung HUANG, Chiayi County (TW)

Correspondence Address: LADAS & PARRY LLP, 224 SOUTH MICHIGAN AVENUE, SUITE 1600, CHICAGO, IL, 60604, US

(21) Appl. No.: 11/780,542

(22) Filed: Jul. 20, 2007

(30) Foreign Application Priority Data
Jul. 24, 2006 (TW) 095213050

(51) Int. Cl. E05B 27/04

(52) U.S. Cl. 70/367

(57) ABSTRACT

A lock core cylinder includes a key plug having a first pin hole, a plug case receiving the key plug and having a notch, and a ring sleeved around the key plug adjacent to the plug case, and having a lug projecting axially and forwardly and extending into the notch, a second pin hole formed in the lug, and a radially and outwardly projecting protrusion movable between an engaging position and a disengaging position and engageable with a lock housing that receives the lock core cylinder. A pin chest is connected to the plug case and has a third pin hole. First and second pins are disposed movably within the first, second and third pin holes.

### CROSS-REFERENCE TO RELATED APPLICATION

This application claims priority of Taiwanese Patent Application No. 095213050 filed on Jul. 24, 2006.

### BACKGROUND OF THE INVENTION

1. Field of the Invention

This invention relates to an interchangeable lock core cylinder, more particularly to one that has a simplified construction.

2. Description of the Related Art

It is known to provide an interchangeable or removable lock core that is placed within a lock housing and that can be removed therefrom for replacement or renewal. For example, U.S. Pat. Nos. 4,953,373, 4,386,510, and Re31910 disclose a removable lock core that includes a plug housing receiving a key plug, and a pin housing integral with the plug housing and receiving a plurality of pins. The plug housing is recessed in an intermediate part thereof to receive a control ring having a protrusion that can engage or disengage from a slot formed in a lock housing. The lock core can be removed from the lock housing when the protrusion disengages from the slot. In such a lock core, as the control ring is provided in an intermediate part of the plug housing and as three aligned control pins are needed to cooperate with the control ring due to the presence of a thickened portion in the control ring, inconveniences are encountered in fabricating and assembling the components of the lock core.

U.S. Pat. No. 5,070,715 discloses a lock core cylinder which includes a plug housing integral with a pin chest and receiving a key plug. The pin chest has a transverse bore receiving a locking pin for engagement in a recess formed in a lock core housing, and a locking pin stop latch disposed in the pin chest transversely of the locking pin in order to limit the locking pin from retraction. The lock core cylinder further includes an actuating ring sleeved around the key plug at a rear end of the plug housing to selectively operate the locking pin and the locking pin stop latch, and a control pin disposed in the key plug to control the actuating ring. The afore said construction is made up of a multiplicity of components and thus is complicated.

### SUMMARY OF THE INVENTION

The object of the present invention is to provide an interchangeable lock core cylinder that can be manufactured easily at a low cost.

According to one aspect of this invention, an interchangeable lock core cylinder for use in combination with a lock housing comprises: a key plug having a radial first pin hole; a plug case receiving rotatably the key plug and having a notch provided in one end of said plug case; and a ring sleeved around the key plug adjacent to the end of the plug case, and having a lug projecting axially into the notch, a second pin hole formed in the lug for alignment with the first pin hole, and a radially and outwardly projecting protrusion adapted to engage the lock housing. The protrusion is movable between an engaging position and a disengaging position. The lock core cylinder further comprises a pin chest connected integrally to the plug case and having a third pin hole for alignment with the second pin hole, and first and second pins disposed movably within the first, second and third pin holes.

According to another aspect of the invention, an interchangeable lock core cylinder for use in combination with a lock housing, comprises: a key plug having a radial first pin hole; a plug case receiving rotatably the key plug and having a notch provided in one end of the plug case; a ring sleeved around the key plug adjacent to the end of the plug case, and having a lug projecting axially into the notch, a second pin hole formed in the lug for alignment with the first pin hole, and a radially and outwardly projecting protrusion adapted to engage the lock housing. The protrusion and the lug are disposed at different angular positions of the ring. The lock core cylinder further comprises a pin chest connected integrally to the plug case and having a third pin hole for alignment with the second pin hole; and first and second pins disposed movably within the first, second and third pin holes.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is an exploded view of a lock core cylinder embodying the present invention;

FIG. 2 is a perspective view of the lock core cylinder in an assembled state;

FIG. 3 is a sectional view showing that the lock core cylinder is placed in a lock housing;

FIG. 4 is a perspective view of the lock core cylinder placed in the lock housing;

FIG. 5 is the same view as FIG. 2 but showing that a protrusion in the lock core cylinder is in its disengaging position;

FIG. 6 is the same view as FIG. 3 but showing that the protrusion is in its disengaging position; and

FIG. 7 is the same view as FIG. 3 but showing that an operating key is inserted into the lock core cylinder instead of a control key.

### DETAILED DESCRIPTION OF THE PREFERRED EMBODIMENT

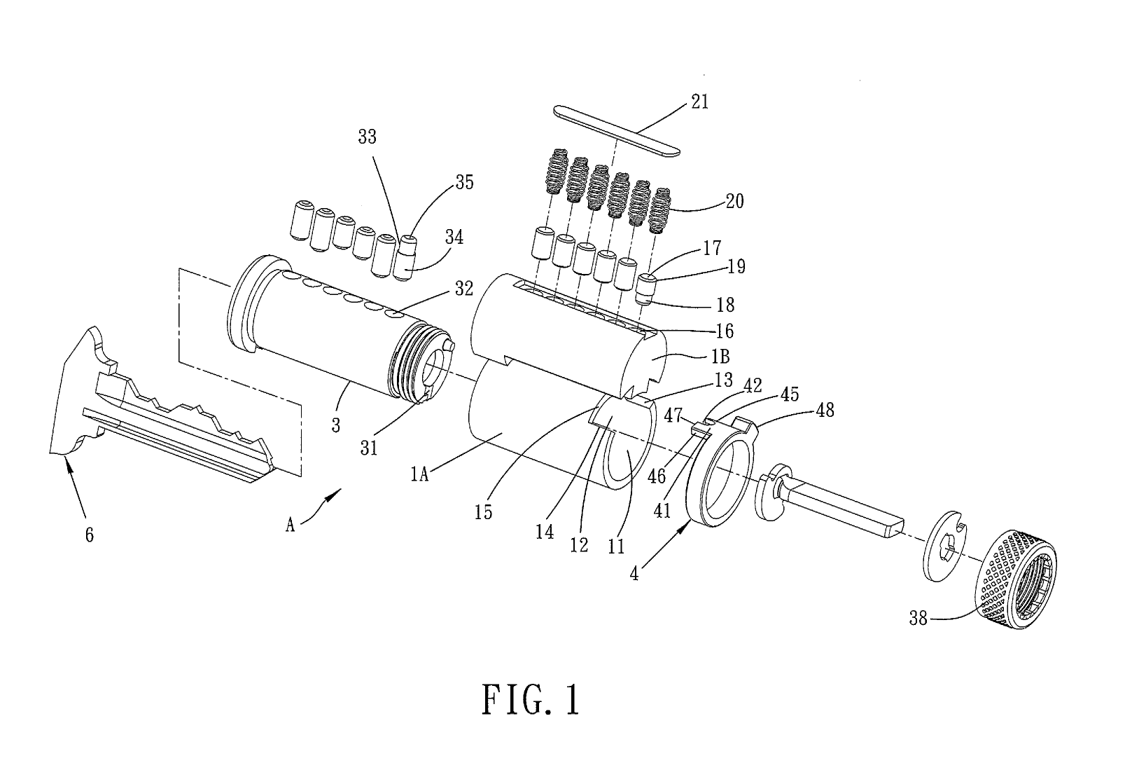

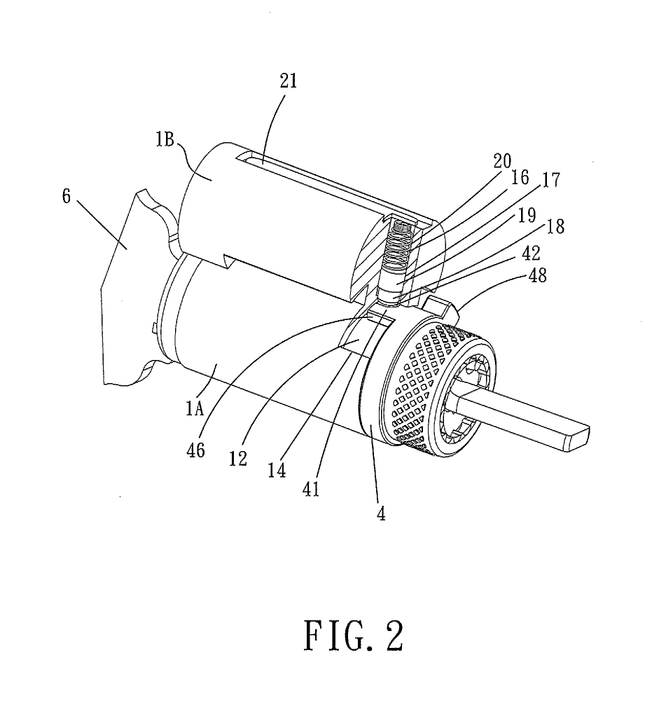

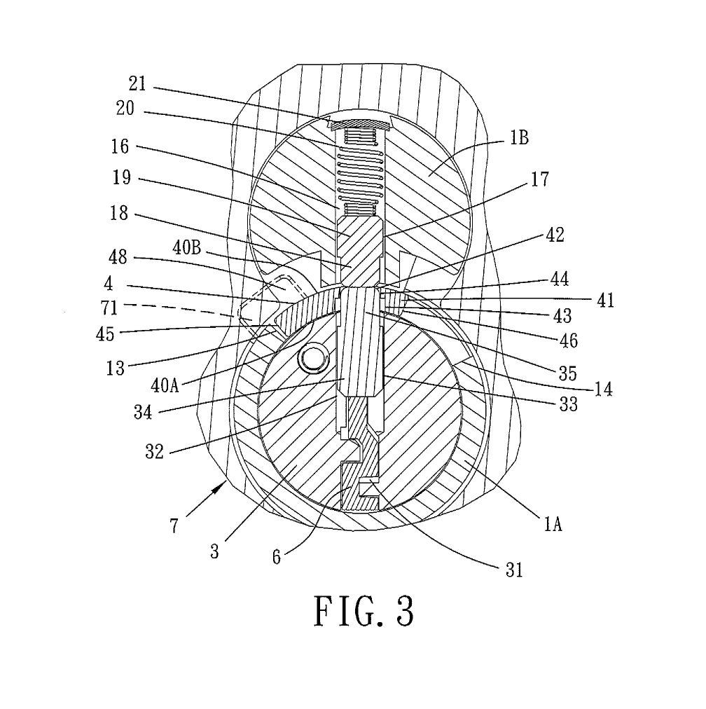

Referring to FIGS. 1 and 2, there is shown an interchangeable lock core cylinder (A) embodying the present invention, which, in use, is combined with a lock housing shown at 7 in FIG. 3. Typically, the lock housing 7 has a cavity 71 associated with a receiving hole that receives the lock core cylinder (A). In use, the lock housing 7 is installed within a handle knob or an L-shaped handle lever, or within an outside deadbolt operator that is disposed at the outside of a door. By way of example, the lock core cylinder (A) and the lock housing 7 will be described as being applied to the outside deadbolt operator. However, the application thereof should not be limited thereto.

As shown in FIGS. 1 and 2, the lock core cylinder (A) includes a plug case (1A) and a pin chest (1B) that are connected to each other to form a unitary body. The plug case (1A) has an axial hole 11, a notch 12 that is disposed at a rear end of the plug case (1A), first and second notch edges 13 and 14 that are spaced apart in a circumferential direction of the plug case (1A) and that bound the notch 12, and a third notch edge 15 that interconnects the first and second notch edges 13, 14 and that also bounds the notch 12.

The lock core cylinder (A) further includes a key plug 3 disposed rotatably within the axial hole 11 of the plug case (1A), and a ring 4. The key plug 3 has a key hole 31 that extends axially in the key plug 3, and a first pin hole 32 formed radially in the key plug 3 and proximate to the notch 12 of the plug case (1A).

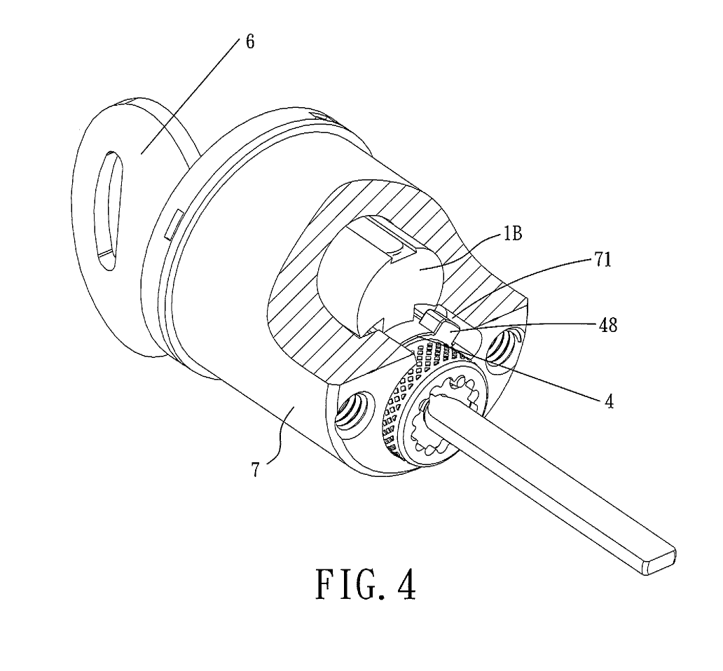

The ring 4 is sleeved around the key plug 3 adjacent to the rear end of the plug case (1A) and is retained thereat by a locking screw 38 attached threadedly to the key plug 3. The ring 4 has a lug 41 projecting axially into the notch 12 so that the lug 41 extends between the first and second notch edges 13, 14. The lug 41 has opposite first and second sides 45, 46 which are interconnected by a third side 47, and a second pin hole 42 to be aligned with the first pin hole 32. A protrusion 48 projects radially and outwardly from the ring 4 for engagement with the cavity 71 (see FIGS. 3 and 4) formed in the lock housing 7. The protrusion 48 is movable between an engaging position and a disengaging position when the lug 41 rotates limitedly within the notch 12 and between the first and second notch edges 13, 14. The protrusion 48 and the lug 41 are disposed at different angular positions of the ring 4 so that the protrusion 48 is spaced apart angularly from the lug 41.

A third pin hole 16 is formed in the pin chest (1B) for alignment with the first and second pin holes 32, 42. A first pin 33 and a second pin 17 are movably disposed in a space formed by the first, second and third pin holes 32, 42, 16. A spring 20 is provided to bias the first pin 33 and the second pin 17 to move downward and is disposed within the third pin hole 16 which is covered by a cover plate 21.

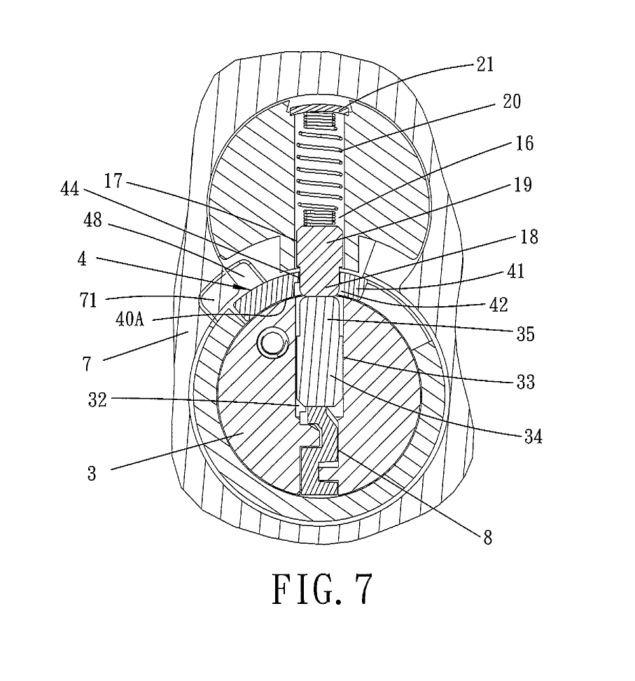

As shown in FIGS. 3 and 7 the first and second pins 33, 17 respectively have contact surfaces that contact each other and that define a shear line for the first and second pins 33, 17. The lug 41 has an inner surface 40A facing the key plug 3, and an outer surface (40B) facing the pin chest (1B) and substantially flush with an outer surface of the plug case (1A). The contact surfaces of the first and second pins 33, 17 can be flush with the outer surface (40B) of the lug 41 to enable the ring 4 to rotate along with the key plug 3. In addition, the aforesaid contact surfaces can also be flush with the inner surface (40A) of the lug 41 so that the ring 4 does not rotate along with the key plug 3.

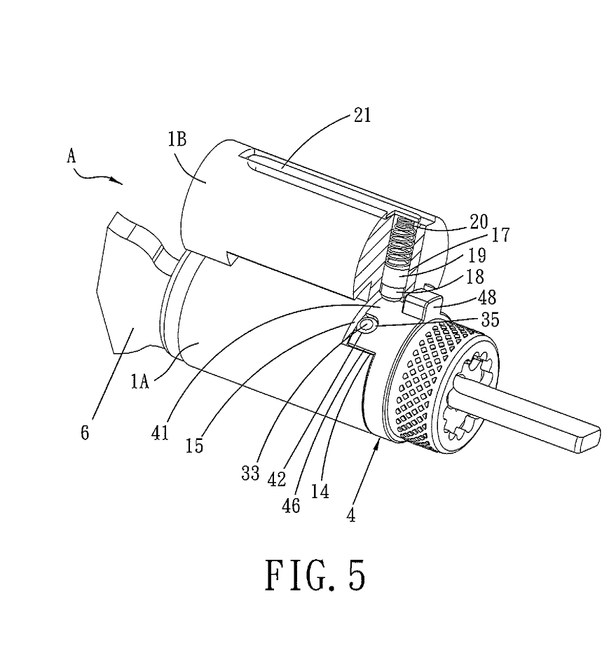

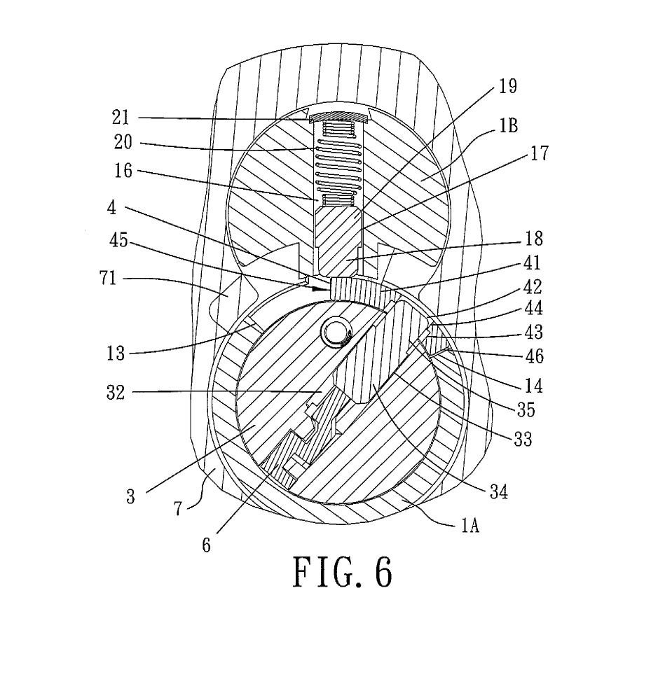

Referring to FIG. 4 in combination with FIG. 3, the plug case (1A) and the pin chest (1B) are mounted within the lock housing 7, and the protrusion 48 of the ring 4 is in the engaging position in which the protrusion 48 is engaged in the cavity 71 of the lock housing 7. A control key 6 is inserted into the key hole 31 of the key plug 3 to lift the first and second pins 33, 17 so that the contact surfaces of the first and second pins 33 and 17 are flush with the outer surface (40B) of the lug 41. When the control key 6 is rotated, the key plug 3 and the ring 4 are turned together relative to the plug case (1A), and the protrusion 48 disengages from the cavity 71 of the lock housing 7 as shown in FIGS. 5 and 6. As the protrusion 48 disengages from the cavity 71, the entire lock core cylinder (A) is separable from the lock housing 7. In this state, the lock core cylinder (A) may be removed from the lock housing 7, and a new lock core cylinder may be put into the lock housing 7.

As stated above, the lug 41 of the ring 4 has the first and second sides 45, 46. When the first side 45 moves to the first notch edge 13, the protrusion 48 is in its engaging position to engage the cavity 71 of the lock housing 7 as shown in FIGS. 3 and 4. When the second side 46 moves to the second notch edge 14, the protrusion 48 is in its disengaging position to disengage from the cavity 71 of the lock housing 7 as shown in FIGS. 5 and 6.

Referring once again to FIG. 1, the first pin 33 has first and second sections 34, 35, and the second pin 17 has third and fourth sections 18 and 19. The second section 35 contacts the third section 18. In order to prevent the first pin 33 from being released accidentally from the first pin hole 32 in the key plug 3 and from the second pin hole 42 in the ring 4 during assembly or operation, the first and second sections 34, 35 are provided with different dimensions. In particular, the first section 34 is larger in cross section than the second section 35. In addition, the second pin hole 42 in the ring 4 is provided with a wide section 43 adjacent to the key plug 3, and a narrow section 44 adjacent to the pin chest (1B). The second section 35 is extendable into the narrow section 44 from the first pin hole 32, whereas the first section 34 is not extendable into the narrow section 44 from the first pin hole 32. As such, the first pin 33 can be prevented from being released from the second pin hole 42. On the other hand, the third section 18 of the second pin 17 is provided with a cross section narrower than that of the fourth section 19 so that the third section 18 can extend into the narrow section 44 of the second pin hole 42.

Referring to FIG. 7, the protrusion 48 is engaged in the cavity 71 of the lock housing 7, the first and second pin holes 32, 42 are aligned with the third pin hole 16, and the second pin 17 is moved downward by the spring 20 so that the third section 18 extends into the second pin hole 42. When an operating key 8 is inserted into the key plug 3, the operating key 8 lifts the first and second pins 33, 17 so that the contact surfaces of the first and second pins 33, 17 are flush with the inner surface (40A) of the lug 41. In this state, only the key plug 3 can be rotated through the operating key 8 for a door opening or door closing operation. As the ring 4 does not rotate, the protrusion 48 is placed assuredly in its engaging position to retain the plug case (1A) and the pin chest (1B) in the lock housing 7.

In order to provide better installation tolerance or installation flexibility, the second pin hole 42 in the lug 41 of the ring 4 may be provided with an oblong shape other than a circular shape. In the above-described preferred embodiment, the second pin hole 42 is an oblong hole that is formed between the first and second sides 45, 46 of the lug 41 and that opens at the third side 47 as best shown in FIG. 1.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

We claim:

1. An interchangeable lock core cylinder for use in combination with a lock housing, comprising:
a key plug having a radial first pin hole;
a plug case receiving rotatably said key plug and having a notch provided in one end of said plug case;
a ring sleeved around said key plug adjacent to said one end of said plug case, and having a lug projecting axially into said notch, a second pin hole formed in said lug for alignment with said first pin hole, and a radially and outwardly projecting protrusion adapted to engage the lock housing, said protrusion being movable between an engaging position and a disengaging position;
a pin chest connected integrally to said plug case and having a third pin hole for alignment with said second pin hole; and
first and second pins disposed movably within said first, second and third pin holes.

2. The interchangeable lock core cylinder of claim 1, wherein said first pin has a first section, and a second section smaller in cross section than said first section, said second pin having a third section, and a fourth section larger in cross section than said third section, said second section contacting said third section.

3. The interchangeable lock core cylinder of claim 2, wherein said second pin hole has a wide section adjacent to said key plug, and a narrow section adjacent to said pin chest, said second and third sections being extendable into said narrow section, said first section being unable to extend into said narrow section.

4. The interchangeable lock core cylinder of claim 1, wherein said plug case has first and second notch edges that bound said notch and that are opposite to each other along a circumferential direction of said plug case, said lug extending between said first and second notch edges, and having first and second sides, one of which moves to said first notch edge when said protrusion is in said engaging position, and the other one of which moves to said second notch edge when said protrusion is in said disengaging position.

5. The interchangeable lock core cylinder of claim 4, wherein said lug further has a third side interconnecting said first and second sides, said second pin hole being formed between said first and second sides and opening at said third side.

6. The interchangeable lock core cylinder of claim 1, wherein:
said lug has an inner surface facing said key plug and an outer surface facing said pin chest;
said first and second pins respectively have contact surfaces that contact each other;
said contact surfaces can be flush with said outer surface of said lug so as to enable said ring to rotate along with said key plug; and
said contact surfaces can also be flush with said inner surface of said lug so that said ring does not rotate along with said key plug.

7. An interchangeable lock core cylinder for use in combination with a lock housing, comprising:
a key plug having a radial first pin hole;
a plug case receiving rotatably said key plug and having a notch provided in one end of said plug case;
a ring sleeved around said key plug adjacent to said one end of said plug case, and having a lug projecting axially into said notch, a second pin hole formed in said lug for alignment with said first pin hole, and a radially and outwardly projecting protrusion adapted to engage the lock housing, said protrusion and said lug being disposed at different angular positions of said ring;
a pin chest connected integrally to said plug case and having a third pin hole for alignment with said second pin hole; and
first and second pins disposed movably within said first, second and third pin holes.

8. The interchangeable lock core of claim 7, wherein said lug has an outer surface substantially flush with an outer surface of said plug case.
